(19) United States
(12) Patent Application Publication
(10) Pub. No.: US 2009/0208402 A1
(43) Pub. Date: Aug. 20, 2009

(54) Process and system for producing commercial quality carbon dioxide from fine particle limestone

(76) Inventor: Robert A. Rossi, North Bergen, NJ (US)

Correspondence Address: KLAUBER & JACKSON, 411 HACKENSACK AVENUE, HACKENSACK, NJ, 07601, US

(21) Appl. No.: 12/070,900

(22) Filed: Feb. 20, 2008

(51) Int. Cl. C01B 13/18; C01B 31/20; B01J 8/24

(52) U.S. Cl. 423/438; 423/637; 422/187

(57) ABSTRACT

The invention features methods and systems for producing commercial quality carbon dioxide (CO₂) of 90% to +99% purity using, wet, fine particle limestone produced in a manufacturing operation, for instance, a limestone quarry as a feedstock to a multi-stage limestone calcination process. This process may be fueled with negative cost waste water treatment plant (WWTP) sludge, biomass, coal, or other low cost solid fuels. High reactivity lime product required in the an adjacent paper mill's PCC manufacturing plant is also produced, and steam and heated boiler feed-water is generated and exported to the mill's steam distribution and generation system as well as hot process water for use in the mill's manufacturing operation. The system for calcining fine particle limestone produced in a quarry manufacturing operation and converting it to lime and CO₂ comprises a calciner and a combustor linked by a moving media heat transfer (MMHT) system or apparatus. The MMHT system or apparatus thermally links separate fluid bed combustion (exothermic) and calcination (endothermic) stages with a solid particulate media. The fluid bed calcination stage is fluidized with steam. The system further comprises a dryer/pre-heater that utilizes exhausted heat from the calcination stage.

### FIELD OF THE INVENTION

The present invention provides methods and systems for producing commercial quality carbon dioxide (CO₂) and calcined calcium carbonate (“lime”). Further, the present invention provides an improved process for calcining fine particle limestone as produced, for instance, in a limestone quarry. The CO₂ and lime can, for instance, be recombined to produce precipitated calcium carbonate (PCC) for use within a paper mill manufacturing operation. Further, the fine particulate limestone may be converted to commercial quality CO₂ and lime using only negative cost waste-water treatment plant sludge (WWTPS), low cost biomass or other solid fuels such as coal, petroleum coke, etc. Biomass fuels, are “carbon-neutral” with regards to global environmental impact.

### BACKGROUND OF INVENTION

The production of high quality limestone products as produced in a quarry generates fine particle limestone during various crushing, grinding, screening and washing operations. Due to its lower market value, this fine limestone represents an economic loss. Such fine particle limestone has a particle size between one (1) micron and five (5) millimeters but typically between five (5) microns and 100 microns.

Also, fine particle, partially calcined limestone is generated during the manufacture of high quality, larger particle lime products as produced in rotary and shaft kilns. This partially calcined fine particle limestone is created by thermal decrepitation and mechanical attrition in the kiln and is blown out of it and captured in pollution control equipment. It represents an economic loss since the energy investment in partially calcining this discarded fine particle limestone is not re-covered.

There is, however, a need for fine particle lime produced by calcining such limestone sources in cement manufacture; dry scrubbers for electric utility power boilers; and PCCs used as paper fillers in the paper industry. It is preferred that the fine particle lime supply for such uses have a low impurity content.

The calcination of fine particle limestone usually occurs in flash (a.k.a., “gas suspension”) or bubbling fluidized bed calciners fired with high cost premium fuels (oil, natural gas, etc.) so as not to contaminate the fine lime product with fuel ashes from lower cost fuel sources such as biomass, coal, petroleum coke, etc. The calcination reaction is as follows;

CaCO₃₍ₛ₎→CaO₍ₛ₎+CO_{2(g)},+42.5 Kcal/gm mole (891,764 Kcal/metric ton CaO)

Also, this calcination step almost always occurs at the quarry which has little need for hot process water or steam.

Further, many integrated pulp and paper mills have PCC “satellite plants” that supply this important paper filler to the paper mill. Such satellite PCC production requires imported industrial lime feedstock combined with CO₂ captured from adjacent Kraft pulp mill lime mud calciner off-gases.

Paper mills un-associated with pulp manufacture, however, must import PCCs produced at merchant plants located elsewhere. Such merchant PCC production requires a finely divided lime feedstock, impurity removal from same, and the creation of engineered particle size PCCs using specialized technology utilizing the familiar lime slaking and re-carbonation reactions;

CaO₍ₛ₎+H₂O→Ca(OH)₂₍ₛ₎

Ca(OH)₂₍ₛ₎+CO₂→+CaCO₃₍ₛ₎

The CO₂ required for the second reaction is usually sourced from the same calciner that produces the lime feedstock from fine particle lime or from power boiler stack gases. This CO₂, however, is always diluted with fuel combustion products exiting the kiln or boiler which creates an operating cost burden on the PCC manufacturing step.

Further, such un-associated paper mills having an imported PCC need are also major users of steam and hot process water and also produce WWTPS that is typically disposed of in high-cost landfills thereby losing any associated fuel energy value.

It would, therefore, be beneficial to have a fine particle limestone calcination facility located at an un-associated paper mill having a dedicated PCC facility. It would be further beneficial if that calcination process utilized the paper mill's WWTPS as the primary calciner fuel source while also recovering rejected calciner enthalpy in the form of process steam and hot water. These recovered energy forms would be used by other manufacturing operations within the paper mill. It would be still further beneficial if the CO₂ produced in such a calcination process be recovered in a concentrated form so as to economically benefit the PCC manufacturing process.

Further, it would be useful to capture concentrated CO₂ from fine particle limestone calcination at quarries where the captured CO₂ could be sold as a “merchant industrial gas” or sequestered as part of a “greenhouse-gas capture” project.

Numerous advances have been previously made related to various aspects of limestone calcinations or related thermal processes. U.S. Pat. No. 2,212,446 teaches limestone calcination in a 100% steam atmosphere (a claim of the disclosed invention) using an indirect heated rotary calciner. U.S. Pat. No. 2,700,592 teaches using moving media heat transfer (MMHT) between an endothermic fluidized bed process and an exothermic fluidized bed sulfide ore roasting process. U.S. Pat. No. 3,991,172 teaches direct combustion products calcination of fine limestone by passing the limestone through a fluidized bed of a “granular heat carrier medium”. U.S. Pat. No. 4,389,381 teaches using MMHT by passing fine limestone through an inert heat carrier contained in an endothermic fluidized bed and using a coal fueled exothermic fluidized bed to re-heat the heat carrier. Ash is separated from the re-heated heat carrier prior to calcination. Calcination is accomplished in an air atmosphere of unspecified composition. U.S. Pat. No. 4,707,350 teaches calcination of fine limestone in an electrically heated fluid bed calciner fluidized in a 100% CO₂ atmosphere with recovered CO₂ as the fluidizing gas. U.S. Pat. No. 5,230,880 teaches calcination of fine limestone in an electrically heated fluid bed calciner fluidized in an atmosphere. The fine limestone is passed through a bed of coarser calcined limestone particles that act as a heat transfer media between the fine limestone and the electric heaters. U.S. Pat. No. 5,653,948 teaches an indirectly heated fluid bed calciner using electricity or direct oil/gas firing to calcine very fine limestone particles. The limestone is injected beneath a coarser limestone bed that acts as the heat transfer medium. United States Patent Application Publication No. 2006/0039853 teaches a process to separate CO₂ from utility boiler stack gases with an “activated” CaO sorbent and then separately re-generating the sorbent and recovering the CO₂ in a steam blanketed vacuum calciner.

### SUMMARY OF THE INVENTION

In a first aspect, the present invention features a process for producing CO₂ comprising:

(a) feeding fine limestone obtained from a manufacturing operation to a bubbling fluid bed calciner thermally linked by moving media heat transfer (MMHT) using a solid particulate media to a circulating fluid bed combustor wherein the MMHT provides heat input and residence time control for calcining fine limestone;

(b) recycling the solid particulate media being from said calciner to said combustor; and

(c) recovering CO₂ and lime product from the bubbling fluid bed calciner.

In some embodiments, the process features after step a) recovering excess energy from the process as steam and/or hot water. The combustor may be provided with wet WWTPS or biomass as primary fuels.

In some embodiments, steam is provided to the fluid bed calciner as a fluidization and diluent gas. The steam may also serve to catalyze the calcination reaction. Hot CO₂, steam, and lime product is normally produced from the fluid bed calciner and in most instances provided to a cyclone separator. A cyclone separator may separate coarse lime product and feed the hot CO₂, steam and residual fine lime product mixture to a wet limestone dryer/pre-heater.

In preferred embodiments, the process features additionally providing wet, fine limestone sufficiently near the fluid bed calciner and a dryer/pre-heater such that exiting gases from the calciner substantially dry the wet, fine lime limestone and then subsequently pre-heat the relatively dry fine limestone before it is fed to the calciner.

In some embodiments, the CO₂ in the exiting dryer/pre-heater gases may be separated from the steam by condensing it by water contact in a cooling tower. In additional embodiments, hot water created by steam condensation and quenching exiting calciner gases may be returned to the paper mill's process hot-water circuit.

In yet other embodiments, the method makes use of a calciner and a dryer/pre-heater operating in countercurrent gas/solids flow wherein wet, fine limestone is dried by exiting calciner gases and then pre-heated before being fed to the calciner. In some embodiments, the fluid bed calciner is a bubbling fluidized bed calciner wherein the bed may comprise reheated solid particulate media returning from the circulating fluid bed combustor.

In some embodiments, the method features feeding a makeup media for said moving media to said circulating fluid bed combustor. The makeup media may be alumina, silica, mullite or other solid, inert materials noted for strong thermal cycling and mechanical strength characteristics.

In additional embodiments, the method features providing a sorbent limestone to said circulating fluid bed combustor. Such sorbent limestone may be useful to neutralize fuel derived sulfur dioxide (SO₂).

In yet other embodiments, the combustor may utilize fossil fuels such as coal, waste coal, petroleum coke, shredded tires, fuel oil, and natural gas which may serve as backup fuels in the event of unavailability of adequate said primary fuels.

In some embodiments the method features generating either low-pressure saturated steam or high pressure superheated steam by heat exchange with hot combustion products. These features may allow generating low pressure saturated steam or high-pressure super heated steam for export to a steam system of a paper mill, the calciner, or internal process steam service needs. In addition, in some instances, the methods and systems may feature preheating air inside the combustor by heat exchange with hot combustion products. Further, the methods and systems may include recovering heat from the calciner's hot lime product using an indirect water cooled fluid bed device to generate hot boiler feed-water or hot process water.

Additionally, the method may include injecting the dry fine limestone feed to the calciner at the base of the fluidized media bed of the calciner. This may help to maximize fine limestone particle residence time thereby ensuring thorough calcination.

In a second aspect, the present invention provides a system for calcining calcium carbonate contained in fine limestone and converting said calcium carbonate to CO₂ and lime product comprising a bubbling fluid bed calciner thermally linked by MMHT to a circulating fluid bed combustor and wherein the MMHT is reheated and provides heat input and residence time control for calcining the fine limestone. The system comprises a calciner and a combustor linked by a MMHT system or apparatus. The MMHT system or apparatus thermally links separate fluid bed combustion (exothermic) and calcination (endothermic) stages. In some embodiments, the system further comprises a calciner exit gas heat recovery process consisting of a dryer/pre-heater arrangement.

In a third aspect, the present invention provides an integrated system comprising five (5) interconnected, pyro-processing and heat exchange unit operations, namely fine limestone drying/pre-heating, bubbling fluid bed fine limestone calcining, bubbling fluid bed calcine cooling, direct media heating within a circulating fluid bed combustor, and combustion products heat recovery and steam generation. The calciner and dryer/pre-heater operate in countercurrent gas/solids flow with wet limestone being dried by exiting calciner gases and the resultant dry fine limestone being pre-heated and then fed to the calciner. The present system provides MMHT to thermally link separate fluid bed combustion (exothermic) and calcination (endothermic) stages. High temperature media, when separated from contaminates, is transported to a lower operating temperature bubbling fluid bed calciner where it surrenders stored heat to satisfy the calciner and preceding dryer/pre-heater's endothermic heat needs. The cooled media exiting the calciner is then returned to a combustor for reheating.

### BRIEF DESCRIPTION OF DRAWINGS

FIG. 1 provides a schematic block diagram of a preferred system of the invention.

FIG. 2 provides a schematic block diagram of a preferred system of the invention.

FIG. 3 depicts a further schematic block diagram providing more detail for the system of the present invention.

FIG. 4 depicts a further schematic block diagram providing additional detail for the system of the present invention.

### DESCRIPTION OF PREFERRED EMBODIMENTS

Unless otherwise specified, as used herein, the following terms mean the following:

By “fine limestone” is meant a dry or water-wet limestone having a particle size between one (1) micron and five (5) millimeters but typically between five (5) microns and 100 microns. Such fine, dry or wet, limestone is usually produced during the quarry production of more marketable limestone grades.

By “waste water treatment sludge” (WWTPS) is meant a primary fuel such as water-wet sludge as produced in a paper mill, other industrial facility, or municipal waste-water treatment plant. This sludge contains organic, and inorganic, materials that may be rejected from various sources. The contained energy content may be in the form of various organic compounds, such as cellulosic matter, etc.

By “biomass” is meant a positive value fuel and may consist of bark, field trimmings, etc. derived from the production of forest products and paper pulp.

By “calcination” is meant a high temperature endothermic (heat is added to drive a chemical reaction) industrial thermal process to thermally dissociate inorganic carbonates (i.e., calcium and magnesium carbonates, a.k.a., limestone) and hydroxides (i.e., aluminum and magnesium hydroxides) into the reactive, solid calcium, magnesium, or aluminum oxides and liberated gaseous reaction products, water vapor and/or carbon dioxide. For example, limestone may be dissociated into carbon dioxide and calcium oxide (a.k.a., lime) with both forwarded to a PCC manufacturing plant

By “calciner” is meant a chamber or apparatus for conducting a calcination reaction. A calciner may be fueled with oil, natural gas, coal or in some cases, biomass and, dependent on the feedstock's physical state may be a rotary kiln or flash calciner as made by FL Smidth, a multiple hearth furnace as made by MHF Services, or shaft kiln or bubbling fluid bed calciner as made by Metso Minerals.

By “bubbling fluid bed calciner” is meant a calciner that uses a solid particulate heat transfer media (e.g., silica, alumina, mullite, etc.) that is suspended (i.e., fluidized) in an upward flowing stream of steam. The upward gas velocity may allow mixing the heat transfer media and limestone particles with steam and evolved carbon dioxide “bubbles,” but is usually not high enough to transport the media out of the bubbling bed while still allowing the lime product to be transported out of the bubbling media bed.

By “combustion” is meant an oxidative combustion (i.e., exothermic) reaction to release thermal energy contained in solid fuels (WWTPS, biomass, coal, waste coal, petroleum coke, shredded tires, etc.) by mixing the fuels with excess air (the oxygen source). Combustion is a widely used high temperature industrial thermal process used to create recoverable energy from fuel combustion products (carbon dioxide, nitrogen, and water vapor). The extracted energy may then be used for a final endothermic purpose, i.e., calcination, heating fluids, drying, raising steam, etc.

By “combustor” is meant a chamber or apparatus that conducts a combustion reaction under controlled conditions and permits the controlled extraction of liberated heat energy for useful process purposes. There are many industrial combustors and the optimal choice is determined by fuel type and the desired end use of the extracted energy, i.e., steam production, hot water production, gases (air, etc.) heating, process heat transfer fluid heating, or solid particulate moving heat transfer media heating.

By “moving media heat transfer (MMHT)” is meant a means or process for transferring exothermic heat generated by solid fuel combustion process in one vessel to an endothermic calcination reaction in another vessel. For example, typical calcination processes utilize in situ (in the same vessel as calcination) fuel combustion. Many of these calcination processes use ash-free, higher cost liquid and gaseous fuels (oil, natural gas) since ashes contained in much lower cost solids fuels would contaminate the calcine product. MMHT allows low cost fuel use while avoiding ash contamination. By using MMHT, a calciner's endothermic reaction heat may be transported to the calciner by a solid particulate heat transfer media that freely flows back-and-forth between a combustor and a calciner. Many low cost solid fuels are effectively combusted in a circulating fluid bed combustor, and many calcination reactions effectively occur in bubbling fluidized bed reactors. MMHT provides a fluidizable solid particulate heat transfer media that freely flows between separated steps. Thereby, MMHT provides for extracting released heat in a combustor and then transferring that same heat into a calciner. In exemplary MMHT systems, the solid particulate heat transfer media has a larger size particle than the calcine's such that the calcine passes through the fluidized media bed and is fully calcined without ash cross-contamination. The calciner step's operating temperature is lower than the combustor's such that the appropriate contained media heat is transferred to the calciner and the media is then returned to, and re-heated in, the higher temperature combustor. In other exemplary systems, MMHT is facilitated by steam catalysis which lowers the calciner temperature thereby creating an effective temperature differential between the calciner and combustor. Conversely, MMHT facilitates steam catalysis use by permitting flexible calcination atmosphere control by using a separate combustor and calciner

By “circulating fluid bed combustor” is meant a combustor featuring a circulating fluid bed combustor comprised of two fluidized media sections. A lower bubbling fluid bed section contains large particle heat transfer media fluidized by incoming fluidization air. Fine particle media and fuel may be injected into this large media bed. The air velocity is normally insufficient to transport large media particles out of this bed, but sufficient to vertically transport fine particle media and fuel ash media out and into a second section, known as a transport column. Fine media within this latter section absorbs much of the released heat. Some of the fine media contacting the transport section's wall may circulate back to the lower bed. This design is very similar to that used for circulating fluid bed boilers as manufactured by Foster Wheeler.

By “dryer/pre-heater” is meant a multi-stage system with each stage being a cyclone designed to contact a solid particulate with a gas stream and then separating said streams. The wet particulate feed may be introduced proximate into a drying gas entering the first stage cyclone. Drying occurs and the dried solids and spent drying gases are then separated in this first stage cyclone. The exiting, dried particulate may then be introduced proximate to a high temperature gas introduction point entering the second stage cyclone. Pre-heating occurs and the hot solids and spent pre-heating gases are then separated in this second stage cyclone. The exiting second stage gases become the drying gas introduced into the aforementioned first stage cyclone. Hot, pre-heated exiting solids are then forwarded to the calciner. In this manner, hot gases and wet solids move counter-current to each other in an efficient heat transfer process. Such multi-stage cyclonic pre-heaters are like those manufactured by FL Smidth.

The present methods and systems produce commercial quality CO₂ of 90% to +99% purity. The commercial quality CO₂ may be produced using, for instance, very fine particulate wet limestone as the sole feed material. High reactivity “soft-burned” lime product is also produced in an energy efficient manner utilizing readily available low quality and low cost fuels and may be re-combined with the commercial quality CO₂ in an adjacent facility to produce high quality PCCs.

The present methods and systems utilize two particularly key technologies, namely (1) MMHT and (2) steam calcination. The methods of the present invention rely on MMHT to thermally link separate fluid bed combustion (exothermic) and calcination (endothermic) stages. This allows using low cost WWTPS and biomass fuels without contaminating lime with fuel ash. The methods of the present invention result in high quality CO₂ recovery by not commingling ash or combustion products with CO₂ evolved during the calcination reaction. The methods also provide high quality lime since there is no commingling of ash created by the combustion reaction.

By using MMHT, unlike the rotary kiln, shaft kiln, flash calciner, or bubbling fluid bed calcination processes, required enthalpy for fine particulate limestone calcination and drying is not generated in situ within the calciner. Instead, a separate circulating fluid bed combustor burns low value WWTPS, and/or higher quality biomass (bark, tree trimmings, sawdust, etc.) fuel to heat circulating inert, solid media. This high temperature media, when separated from ash contaminates, is then transported to the lower operating temperature bubbling fluid bed calciner where it surrenders its stored heat to satisfy the calciner and preceding dryer/pre-heater's endothermic heat needs. The cooled media exiting the calciner is then returned to the combustor for reheating.

WWTPS is not used in the rotary kiln, shaft kiln, flash calciner, or bubbling fluid bed limestone calcination processes given its high ash and moisture content. While ash contamination alone is a major impediment, WWTPS's high moisture content precludes creation of the high adiabatic flame temperatures required in such calcination processes for effective heat transfer and flame stability.

The most common application of MMHT is in fluid catalytic cracking where a liquid refined crude oil feedstock is thermally “cracked” into various useful vapor fractions (naphtha, gasoline, etc.) in a fluid bed reactor utilizing a re-circulating solid catalyst to both transfer heat and drive the cracking reactions.

The methods described herein also use steam to control limestone calciner CO₂ partial pressure while also catalyzing the reaction and allowing it to proceed at a lower temperature than that found with air based limestone calcination while also providing an easy means to subsequently separate commercial quality CO₂ from the steam. Lowering the calcination temperature facilitates MMHT use by creating a satisfactory temperature differential between the hot media and the calcination temperature thereby permitting rapid heat transfer to occur. Conversely, MMHT facilitates the flexible adjustment of steam/CO₂ mixtures and temperatures in the calciner by not allowing gaseous combustion products to mix with the calcination atmosphere.

The favorable effect of steam on limestone's calcination reaction rate has been infrequently researched with the first significant works by Bischoff (“Kinetics of Thermal Dissociation of Dolomite and Limestone in Various Gas Flows”, Zeitschrift für Anorganische Chemie., vol. 262, 1950) and MacIntire/Stansel (“Steam Catalysis in Calcination of Dolomite and Limestone Fines”, Industrial and Engineering Chemistry, vol. 45, no. 7, July 1953).

More recently, detailed works by Burnham/Stubblefield/Campbell (“Effects of Gas Environment on Mineral Reactions in Colorado Oil Shale”, Fuel, vol. 59, December 1980), Weisweiler/Hoffman (“Effect of Water Vapour on the Calcination of Limestone in a Fluidized Bed Reactor”, Zement-Kalk-Gips (36, Jahrgang), nr. 10, 1983), Khraisha/Dugwell (“Effect of Water Vapour on the Calcination of Limestone and Raw Meal in a Suspension Reactor”, Transactions of the Institute of Chemical Engineers, vol. 69, part A, January 1991), and Wang/Thompson (“The Effects of Steam and Carbon Dioxide on Calcite Decomposition using Dynamic X-Ray Diffraction”, Chemical Engineering Science, vol. 50, no. 9, 1995) have provided greater insight.

These researchers conclude that using a 100% steam atmosphere or steam/air atmospheres of certain ratios result in two key impacts during limestone calcination; (1), an approximate 50° C. to 60° C. (90° F. to 108° F.) lowering of the equilibrium CO₂ dissociation temperature relative to that for 100% air or N₂ and (2), a limited catalytic effect, primarily at lower temperatures. This effect diminishes after a maximum steam concentration is attained and/or as temperature increases.

In the calciner, hot media is introduced along with injected dry fine limestone. Also sufficient fluidizing steam to catalyze the calcination reaction, control calciner temperature and CO₂ partial pressure is injected. All these components are thoroughly mixed in the back-mixed, bubbling fluid bed calciner. Reaction products consisting of lime particles and the gaseous steam/CO₂ mixture exiting the fluid bed calciner are cyclone separated before the largely cleaned, hot, steam/CO₂ mixture reports to the dryer/pre-heater. Reduced temperature media is gravity discharged from the fluid bed calciner and returned to the combustor to renew the heating cycle.

To maximize conversion of the fine limestone to lime and CO₂ a portion of the hot lime is recycled to the calciner to create a higher average lime residence time, at the proper temperature in the calciner, thereby ensuring total conversion of the incoming fine limestone.

The calcination and drying/pre-heating steps in the present invention are process decoupled from the combustion step. This feature of the present invention provides the opportunity for substantial process control within the calciner since the calcination atmosphere can be carefully modeled without the influence of fuel combustion products. The exiting, pre-heated fine limestone particle and exiting gas temperatures leaving the dryer/pre-heater may also be optimized for maximum operability and energy efficiency by balancing the dryer/pre-heater's enthalpy needs with the calciner atmosphere's exiting temperature and volume.

The calcination temperature can be varied between 760° C. (1400° F.) and 854° C. (1570° F.) and typically between 816° C. (1500° F.) and 843° C. (1550° F.), by altering the media circulation rate between the calciner and the combustor. Considering this separation of unit operations, the CO₂ partial pressure exiting the calciner can also be varied between 25% and 90%, but typically 85%, of the dissociation equilibrium CO₂ partial pressure for the calcination reaction within a given steam/CO₂ atmosphere.

Within certain combinations of calcination reaction CO₂ partial pressure and temperatures, the calcination reaction rate may be significantly depressed. To ensure total fine limestone conversion to lime product, the incoming pre-heated limestone may be injected into the base of the calciner, beneath the bubbling media bed, yielding a “hindering effect” of the larger media particle bubbling bed on an upward flowing fine limestone particle thereby providing enhanced residence time in the calciner. The dense media bed acts as a physical barrier to prevent un-calcined limestone particles from exiting the calciner too quickly. See, Talukdar/Mathur, “Residence Time Studies of Fine Particles Circulating through a Fluidized Bed of Coarse Solids”. Department of Engineering, University of New Hampshire. Presented at AIChE 1995 Annual Meeting.

The total enthalpy of exiting calcination gases at a gas temperature not less than 760° C. (1400° F.) and not exceeding 854° C. (1570° F.) may be sufficient to efficiently dry and pre-heat the incoming wet, fine limestone in the dryer/pre-heater while maintaining a dryer/pre-heater exit gas temperature at no less than 88° C. (190° F.) and no greater than 204° C. (400° F.) dependent upon entering wet fine limestone moisture content.

Further, the temperature of the hot fine, dry limestone exiting the dryer/pre-heater and entering the calciner will be between 204° C. (400° F.) and 382° C. (720° F.) but always less than 502° C. (935° F.).

Fuel ash and combustion products are not mixed with solid and gaseous reaction products in the present methods and systems and unlike the rotary kiln, shaft kiln, flash calciner, or bubbling fluid bed calcinations processes, high cost liquid/gaseous fossil fuels are not used. Decoupling also permits the relatively clean hot, gaseous combustion products to transfer sensible heat into combustion air preheating and steam generation using conventional heat exchanger designs.

MMHT allows cost effective equipment design. The large exhaust gas volume from the rotary kiln, shaft kiln, flash calciner, or bubbling fluid bed calcination processes largely derives from fuel combustion products and not the commingled CO₂ reaction product. Decoupling fuel combustion from the fluid bed calciner reduces calciner exit gas volume thereby significantly increasing the lime production rate per unit fluid bed area at the same superficial fluidization velocity. Further, the separate circulating fluid bed combustor is free to operate at a much higher fluidization velocity than the separate bubbling fluid bed calciner. Accordingly, the present methods and systems allow a compact fluid bed calciner with product throughputs equivalent to and perhaps greater than other calcination systems but without the land usage penalty.

Hydrocarbon cracking and pyrolysis processes typically use T to transfer heat from a solid to a gaseous stream whereas the present methods and systems are designed to transfer heat from one fluidized solid to another. The media used for MMHT is selected for its excellent thermal stability and resistance to mechanical decrepitation. Inert materials such as alumina, silica, and mullite are several examples. The selected media's size distribution and specific gravity is such as to allow vertical transport (with fine ashes) at superficial gas velocities between 3.1 and 6.1 meters/sec (10 to 20 feet/second) in the combustor while also developing a bubbling, dense fluid bed in the calciner at superficial gas velocities less than 1.5 meters/second (5 feet/second). The fine limestone particles have a transport velocity well under 1.5 m/s, allowing them to transit through the bubbling media bed, absorbing heat from the media, and undergoing calcination before exiting with the steam/CO₂ gas mixture.

MMHT combined with the associated separation of the combustion and calcination processes allows using 100% steam as a calciner atmosphere diluent and fluidizing gas instead of non-condensable fuel combustion products or just air. Variable steam dilution controls CO₂ partial pressure that impacts calcination reaction rate. Steam also catalyses the calcination reaction such that it proceeds at a lower temperature than if the fluidization gas was only air. The total volumetric amount of steam also controls CO₂ partial pressure such that the fine limestone calcination reaction rate can occur at an acceptable level while resulting in a steam/CO₂ amount that provides sufficient enthalpy to efficiently dry and pre-heat incoming wet, fine limestone in the dryer/pre-heater. Importantly, using steam permits subsequent economic separation and recovery of commercial quality non-condensable CO₂ from steam using well accepted commercial technologies.

The present invention provides an integrated process system comprising five (5) separate, but interconnected, pyro-processing and heat exchange unit operations; fine limestone drying and pre-heating, bubbling fluid bed limestone calcination, bubbling fluid bed calcine cooling, direct media heating within a circulating fluid bed combustor, and combustion products heat recovery and steam generation. For energy economy reasons, the calciner and dryer/pre-heater operate in countercurrent gas/solids flow with wet fine limestone being dried by exiting calciner gases and the resultant heated fine, dry limestone then being fed to the calciner.

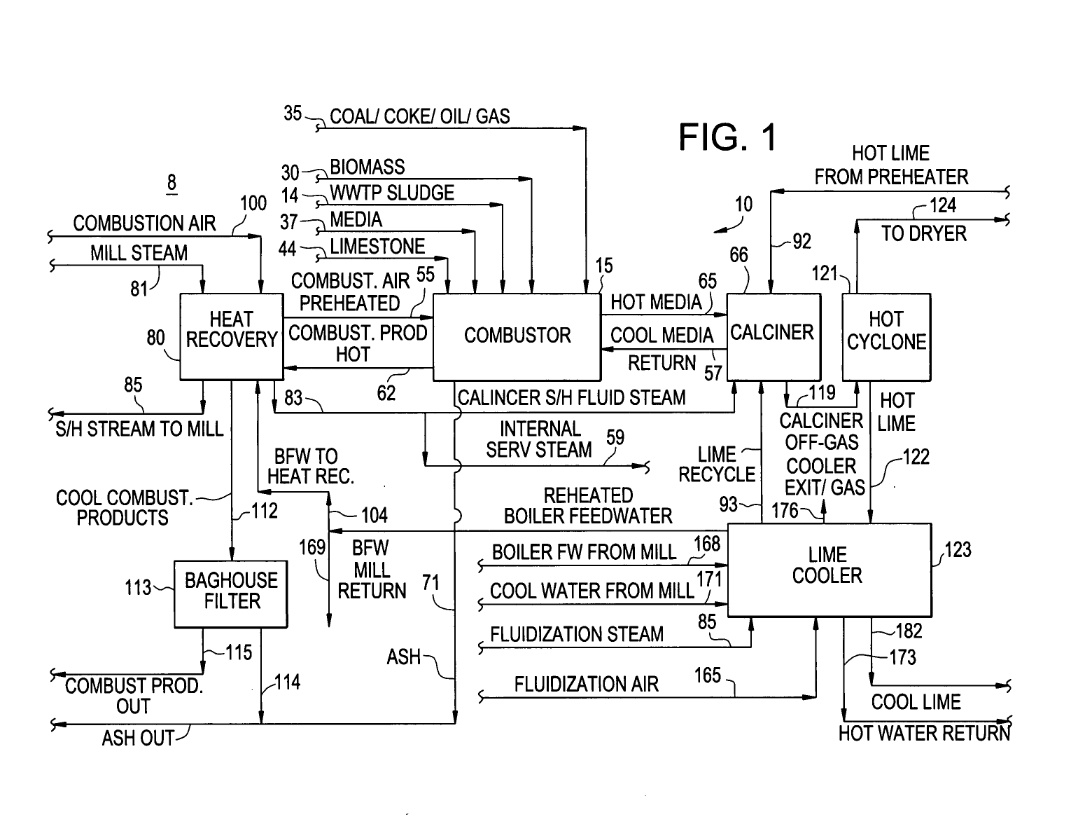

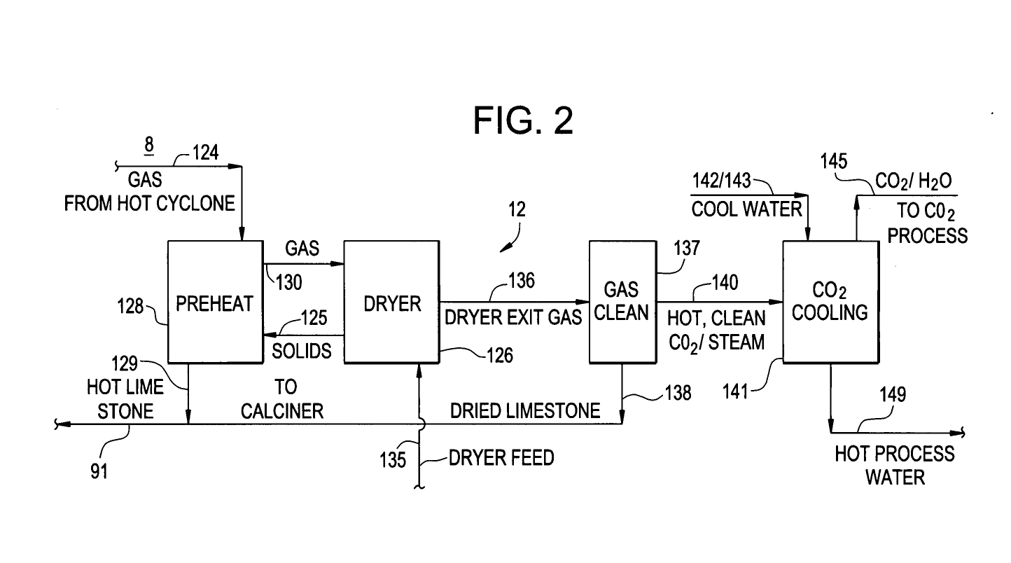

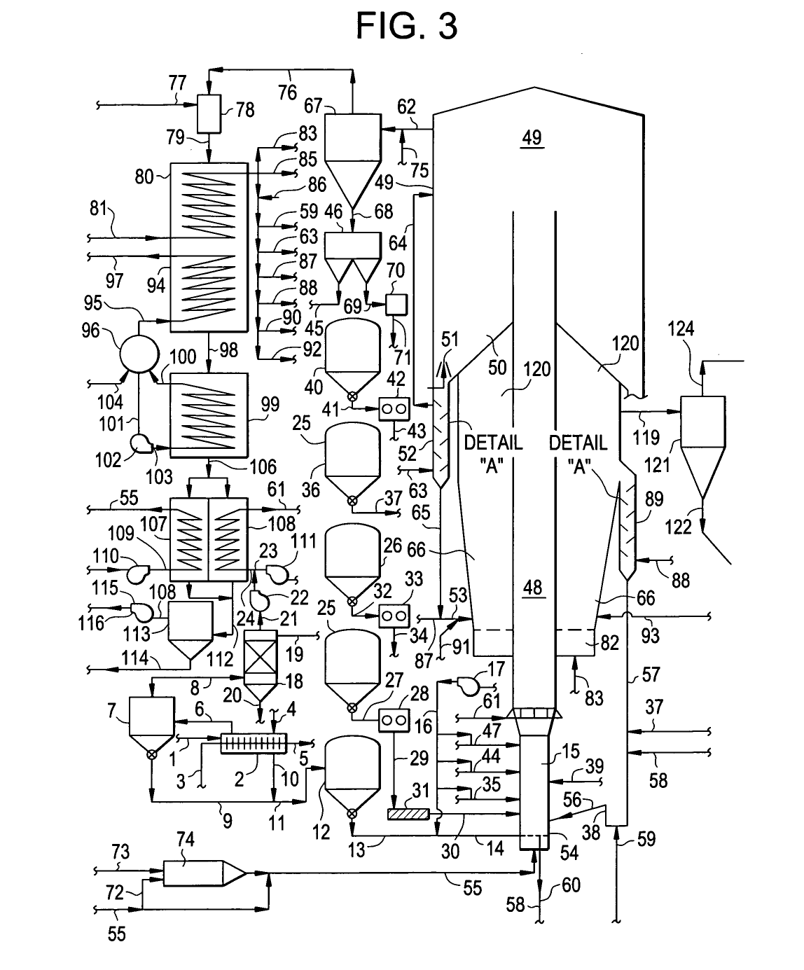

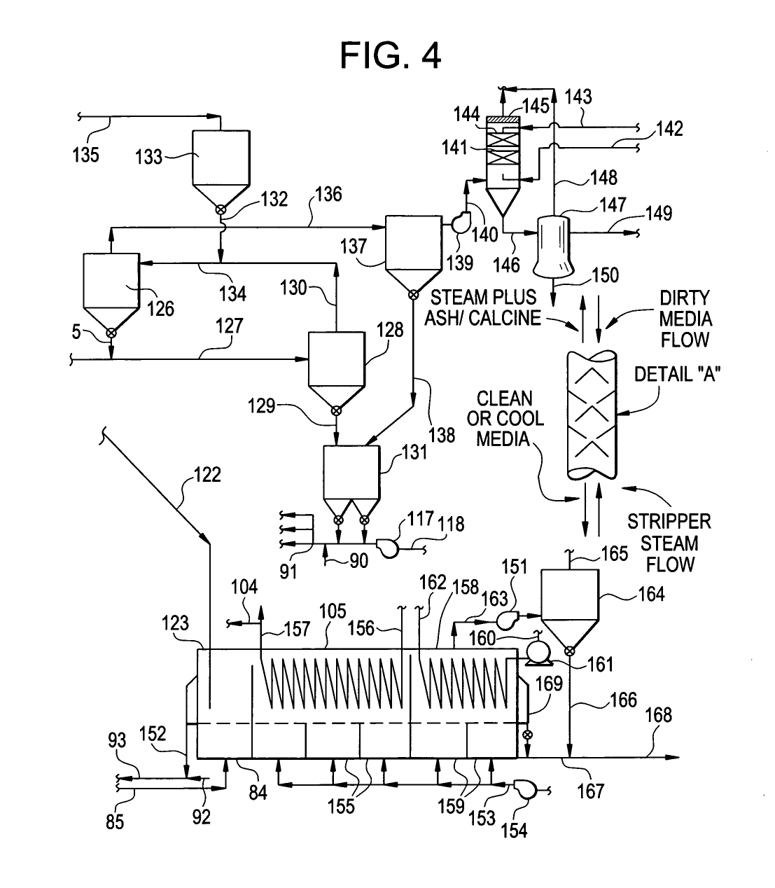

FIGS. 1 and 2 schematically illustrate a system 8 which may be used to practice the present invention. FIGS. 3 and 4 represent a considerably more detailed showing of the system 8. FIG. 1 shows the combustion, heat recovery, calcination and product cooling section 10 of system 8. FIG. 2 shows the dryer/pre-heater, gas cleaning, and CO₂ preparation section 12 of system 8.

FIG. 2 depicts wet, fine limestone 135 provided to the dryer 126 and pre-heater 128 which receives hot gas 124 from the hot cyclone 121 (FIG. 1). Dried and pre-heated fine limestone 138 collected from the gas cleaner 137 is combined with hot limestone 129 from the pre-heater 128 which proceeds 91 to calciner 66 (FIG. 1). Dryer exit gas 136 is cleaned by gas cleaner 137, and the output gases 140 consisting of hot, clean CO₂ and steam are passed to CO₂ cooling means 141. The CO₂ and steam gases are direct water 142/143 quenched and saturated hot water 149 from the cooling means 141 is returned as hot process water to the paper mill. Cooled, water-saturated CO₂ proceeds 145 to a CO₂ gas processing unit beyond the battery limits of this invention.

FIG. 1 depicts a combustor 15 fired at 35 with backup coal, petroleum coke, shredded tires, waste coal, oil and or gas, but uses as its primary fuels, WWTP sludge 14 and/or biomass 30 (bark, sawdust, etc.) and limestone at 44 to react with excess SO₂. Make up media 37 for the MMHT is added as needed. The hot media 65 passes to calciner 66 and after transferring its heat content is returned as cool media 57 to combustor 15 for further heating and recycling. Spent combustion products and ash exit combustor 15 via 62 and report to the heat recovery means 80.

Hot combustion products 62 exiting fluid bed combustor 15 enter the heat recovery means 80 which is provided with saturated steam at 81, re-heated boiler feed-water at 104, and ambient combustion air at 100. Recovered heat is created in the form of superheated high pressure steam 85 exported to the paper mill, pre-heated combustion air 55, pre-heated calcination fluidization steam 83, and internal service steam 59, all leaving the heat recovery means 80.

Calciner 66 receives super-heated fluidization steam 83 from heat recovery means 80. The calciner off-gas 119 consisting of hot CO₂, steam and lime product proceeds to hot cyclone separator 121. Hot lime 122 passes to cooler 123 and some residual partially calcined lime is recycled at 93 to calciner 66. Steam, CO₂ and some residual lime 124 from the hot cyclone 121 pass directly to a dryer/pre-heater 126/128.

Fluid bed lime cooler 123 is seen to have as indirect cooling inputs boiler feed water 168 from the mill, cool water 171 from the mill, fluidization steam 85 and fluidization air 165. Its outputs include reheated boiler feed water 104 which is fed to heat recovery means 80 and also in part returned 169 to the paper mill; a hot water return at 173, cooled lime at 182 to the mill. Hot lime 122 from hot cyclone 121 is fed to the fluid bed lime cooler 123. Cleaned, fluid bed lime cooler exhaust gases at 176 are sent to atmosphere. Cooled combustion products 112 from heat recovery means 80 are sent to a bag house filter 113 at which dry ash 114 is separated from combustion products 112 and added to dry ash 71 from combustor 15 and are then subsequently disposed. Cleaned, cool combustion products at 115 are sent to atmosphere.

A more detailed diagram is provided in FIGS. 3 and 4 which are not to scale and the process stream numerical designations may not necessarily follow in the same sequence as the following description. Stream numbers are denoted by “[ ]” and process equipment items by “( )”. The process depicted in FIGS. 3, and 4 may be divided into seven (7) “islands” as follows: (1) Combustor Fuel Preparation and Solids Handling; (2) Fuel Combustion and Media Heating; (3) Fuel Combustion Products Heat Recovery and Steam Generation; (4) Steam Calcination of Fine Limestone; (5) Wet Fine Limestone Drying and Pre-heating; (6) Carbon Dioxide Recovery; and (7) Calcine Cooling.

### Combustor Fuel Preparation and Solids Handling

The primary fuel, wet WWTPS, is delivered [1] to an indirectly steam heated dryer (2) which utilizes low-pressure, saturated steam [3] provided by the paper mill. Sweep air stream (4) acts to carry the evaporated water and prevent condensation. Condensed steam (5) is returned to the mill's hot process water circuit. The dryer exit gas [6] reports to the fabric filter (7) where it is separated into clean gas air/water mixture [8] and captured dryer carryover solids [9].

Dried WWTP sludge, [10] is mixed with dryer carryover solids [9] and jointly fed [11] to silo (12). The combined streams [13] are pneumatically injected [14] into fluid bed combustor lower section, (15) via pressurized air [16] provided by blower (17).

Clean dryer exit gas [8] reports to a direct contact water cooler (18) using mill process water [19] as the coolant. Condensed hot water [20] is returned to the mill's process hot water system. Cooled, saturated exhaust air [21] is pressurized and delivered via blower (22) to the fluid bed combustor's secondary combustion air inlet stream, [23] to create blended stream [24].

Should WWTPS supply not be available, fuel silos, (25) and (26) provide increasingly higher cost fuels. Silo (25) stores wet biomass fuel, the preferred secondary fuel due to its low cost. The biomass is delivered via [27] to a chipper/shredder (28) after which it [29] is mechanically conveyed (30) to the fluid bed combustor lower section (15) via screw feeder (31) or other appropriate feeding device.

A silo (26) stores costlier fossil fuels such as high sulfur coal, petroleum coke, shredded tires, waste coal, etc. should biomass be unavailable in sufficient quantities to satisfy the system's total energy requirements. They are delivered [32] to a pulverizer (33) pulverized into [34] and then pneumatically conveyed [35] into the lower fluid bed combustor section (15) using transport air [16] provided by blower (17). Fuel is pulverized to ensure rapid combustion and complete ash separation from hot heat transfer media.

The silo (36) contains makeup media to replace that destroyed by cyclic handling when utilizing MMHT. The media can be alumina, silica, mullite or other solid, inert materials noted for strong thermal cycling and mechanical strength characteristics. It is gravity delivered via [37] to the cooled media return “J” valve, (38).

Other fuels injected into the fluid bed combustor lower section (15) are fuel oil or natural gas, [39] which are used for rapid temperature trimming, and startup.

To neutralize emitted SO₂ from solid fossil fuel and fuel oil combustion sorbent limestone is added to the fluid bed combustor lower section (15) at a molar Ca/S ratio between 1.0 and 2.5. This technique is well known to those familiar with fluid bed combustor design. Market quality limestone is stored in silo (40) and conveyed [41] to pulverizer (42) and converted into finely ground limestone [43] prior to pneumatic injection [44] into the lower fluid bed combustor lower section (15) using transport air [16] provided by blower (17). The limestone is pulverized so as to ensure rapid SO₂ sorption and subsequent complete separation from hot heat transfer media.

Lastly, separated combustor ash [45] from storage silo (46) is pneumatically conveyed [47] into the fluid bed combustor lower section, (15) by transport air [16] provided by blower (17). This ash may be recycled to ensure complete fuel carbon content combustion. This technique is well known to those familiar with fluid bed combustor design.

### Fuel Combustion and Media Heating

WWTP sludge [14], other fuels [30, 35, and 39], ash [47] and limestone [44] are injected into the fluid bed combustor lower section (15) of a refractory-lined circulating fluid bed combustor which may be comprised of eight sections, (15), (48), (49), (50), (51), (52) (53) and (54),

Pressurized combustion air, between 1.14 and 1.36 bar (16.5 to 19.7 psia) and pre-heated to between 149° C. and 204° C. (300° F. to 400° F.) is introduced via stream [55] into the cylindrical or rectangular combustor fluidizing air plenum, (54). The amount of air introduced is less than the stoichiometric amount required for full combustion of all fuels entering cylindrical or rectangular combustor section [15] so as to ensure reducing conditions within this combustor section. A gas distribution grid (nozzle or orifice plate) mechanically separates combustor sections [15] and [54]. All these techniques are well known to those familiar with fluid bed combustor design.

Fluid bed combustor lower section (15) is a dense bubbling bed made primarily large media particles. These large media particles are sized to not elutriate when the cross-sectional gas combustion product gas velocity within fluid bed combustor lower section (15) is 6.1 meters per second (20 feet per second). Introduced fuels are gasified and partially combusted in this sub-stoichiometric combustion section, their released heat being absorbed by 788° C. to 882° C. (1450° F. to 1620° F.) cooled media [56] comprised of that returned from the calciner via stream [57], combustor bed return via stream [58], and makeup via stream [37].

Returned cool media [56] enters fluid bed combustor lower section [15] via a “J” valve (38, a.k.a. loop-seal) fluidized with super-heated mill steam [59] at 2.07 bar (30 psia) and 204° C. (400° F.).

As large clinkered ash particles increase in volume in fluid bed combustor lower section (15), they, and some media are gravity discharged [58] via a high-temperature “cone” valve (60) and are externally separated with large media being returned to fluid bed combustor lower section (15) via cooled media stream [56]. Such valve designs are well known to those familiar with fluid bed combustor and calciner design techniques.

Pressurized secondary combustion air [61], between 1.15 and 1.22 bar (16.7 to 17.7 psia) and pre-heated to between 149° C. and 204° C. (300° F. to 400° F.) is provided to complete fuel burnout and circulating media heating in cylindrical or rectangular combustor section (48).

This secondary combustion air introduction technique is widely used with circulating fluid bed boilers. Total excess oxygen exiting fluid bed combustor transport section (48) is between 10% and 35% above that required for stoichiometric combustion and is dependent on a given combined fuel mix's combustion characteristics. The combustor equilibrium temperature for ash, media, and gas will be between 843° C. and 927° C. (1550° F. and 1700° F.).

Due to the high superficial gas velocity of combustion products in fluid bed combustor transport section (48), ash particles and circulating media are vertically transported together into cylindrical combustor freeboard section (49) in excess of the media's transport velocity. This velocity normally does not exceed 6.1 mps (20 fps).

Combustor freeboard section (49) is a cylindrical expanded diameter upper chamber that acts to disengage reheated circulating media at between 843° C. and 927° C. (1550° F. and 1700° F.) from the ash. Its cross-sectional area is such that the gaseous combustion products exiting fluid bed combustor transport section (48) are rapidly expanded to a lower velocity. This lower gas velocity is less than the circulating media particles' vertical transport velocity of 6.1 mps (20 fps) but much greater than the fine ash particles' vertical transport velocity.

In this manner, entrained ash exits combustor freeboard section (49) via stream [62] with fuel combustion products while reheated, largely ash-free media drops by gravity into a combustor storage section (50) that is an integral hot media storage hopper. The volume of combustor storage section (50) is such that it can store hot media when the calcination step requires only 25% of the combustor's heat release capacity.

Depending on calciner enthalpy needs, the reheated circulating media is withdrawn at an appropriate controlled rate from combustor storage section (50) via multiple discharge ports, the flow through each discharge port is being externally controlled by multiple high-temperature cone valves (51). The number of discharge ports and valves is between 4 (four) and 24 (twenty four), the exact amount a function of calciner and dryer enthalpy needs and related fluid bed cross-sectional area.

Reheated circulating media discharged from combustor storage section (50) via multiple cone valves (51) may contain some entrained fine ash. This ash if returned to the calciner with reheated circulating media, may eventually contaminate the PCC manufacturing process. Therefore, the reheated media/ash mix first enters a “cone cap and slope” stripper (52) where the ash contaminated media flows downward, by gravity, over a series of cone caps and slopes (see detail “A” on FIG. 4). Steam [63] at 2.14 bar (30 psia), or less, and pre-heated to 204° C. (400° F.) flows upward through the stripper, separating the ash from the downward flowing circulating media. Such designs are well known to those familiar with refinery fluid catalytic cracking design techniques.

The ash/steam mixture [64] is vented into the combustor freeboard section, (49). Cleaned hot circulating media [65] at between 843° C. and 927° C. (1550° F. and 1700° F.) is gravity discharged from the stripper (52) and reports to the fluid bed calcination section [66] via injectors [53] properly prepared to provide the calcinations and drying/pre-heating steps net endothermic enthalpy need.

Ash and sulfated and un-sulfated limestone particles enter hot cyclone (67) via [62] where most of the incoming solids are separated from hot gaseous combustion products at 843° C. and 927° C. (1550° F. and 1700° F.). The cyclone solids underflow [68] enters silo (46) where it is split into two streams. One stream [45] is the previously mentioned solids recycle flow and the second [69] enters a small water-cooled disc cooler (70). Cooled solids [71] less than 93° C. (200° F.) then exits the system at this point.

The combustor is pre-heated on initial start-up by ambient temperature primary combustion air [72] heated to no greater than 816° C. (1500° F.) via oil or natural gas [73] in a direct-fired heater (74). When the fluidized media bed in fluid bed combustor lower section (15) reaches a suitable temperature, premium fuel (oil, gas, or coal) is injected [39] directly into the bed to elevate its temperature to that needed for satisfactory autogenic primary fuel combustion. Premium fuel use [39] is gradually reduced as WWTP sludge, biomass, and/or fossil fuel feed commence.

### Combustion Products Heat Recovery and Steam Generation

Solids and hot combustion products exiting the combustor are separated in a cyclone with ash exiting the system via a conventional disc cooler. Largely cleaned, hot combustion products then enter multiple convective heat exchangers that, in counter-current series; generate low pressure super-heated calciner fluidization and internal process service steam; high pressure superheated steam for export to the paper mill's steam loop, and preheated combustion air. Cooled combustion products exit to ambient via conventional gas clean-up devices.

Hot, ash laden combustion products [62] exiting combustor freeboard section (49) and entering cyclone (67) may be mixed with ammonia or urea [75] to reduce nitrogen oxide emissions with selective non-catalytic removal technology known to those familiar with fluidized bed boiler design. Should the nitrogen oxide content exiting combustor freeboard section (49) be less than that required by law, then this step is not required.

Hot, largely ash-free combustion products exiting cyclone (67) via [76] may be mixed with natural gas or oil [77] in incinerator (78) to increase the temperature to 982° C. (1800° F.) at a sufficient residence time in incinerator (78) such that any chlorinated organics (dioxins) can be destroyed. Such dioxins may be created if chlorine is contained in any of the solid fossil fuels. This technique is well known to those familiar with waste fuel combustor design. Should the dioxin content exiting combustor freeboard section (49) be less than that required by law, then this step will not be necessary.

Hot gases [79] exiting incinerator (78) enter gas/gas heat exchanger section (80) to superheat low pressure saturated steam [81] delivered from the mill at 2.07 bar (30 psia) to 538° C. (1000° F.). This super-heated steam is then largely directed into two (2) flows; most of it reports to the calciner inlet fluidizing gas plenum (82) via [83]. A smaller amount reports to the calcine cooler inlet fluidizing gas plenum (84) via [85].

The remaining super-heated low pressure steam is tempered with boiler feed-water [86] to 204° C. (400° F.) and directed into six (6) flows; via [87] to the calciner hot media injection valve, (53); via [59] to the combustor cool media injection valve, (38); via [63] to the combustor hot media stripper, (52); via [88] to the calciner cool media return stripper, (89); via [90] to the pre-heated limestone injection line, [91], and via [92] to the calcine re-injection line, [93].

Cooled combustion products exit gas/gas heat exchanger section (80) and enter a second gas/gas heat exchanger section, super-heater (94) which superheats saturated high pressure steam [95] exiting steam drum (96) at between 104.5 bar (1515 psia) and 42.4 bar (615 psia). The super-heated high pressure steam temperature will be between 538° C. (1000° F.) and 399° C. (750° F.) when exported to the paper mill via [97]. The final superheated high pressure steam conditions are compatible with the mill's steam loop.

Cooled combustion products exit super-heater section (94) via stream [98] and enter forced-circulation boiler economizer/evaporator section (99). The steam/water mix [100] generated in economizer/evaporator section (99) enters steam drum (96) where saturated high pressure steam between 104.5 bar (1515 psia) and 42.4 bar (615 psia) exits via [95] and reports to super-heater section (94). Steam drum (96) saturated liquid underflow [101] is extracted and boosted to evaporation pressure by boiler circulation pump (102) being delivered via [103] to economizer/evaporator section (99). Pre-heated boiler feed-water, originally from the mill's boiler-house, enters steam drum (96) via [104] having been pre-heated in calcine cooler section (105).

Still further cooled combustion products leaving economizer/evaporator section (99) via [106] are split into two streams, one entering primary air pre-heater section (107) and the second entering secondary air pre-heater section (108).

Primary air pre-heater section (107) pre-heats primary combustion air delivered via [109] by primary combustion air blower (110) at between 1.15 bar and 1.36 bar (16.7 psia to 19.7 psia). The primary combustion air exiting air pre-heater section (107) via [55] is heated to between 149° C. and 204° C. (300° F. to 400° F.) and then reports to combustor fluidizing air plenum (54).

Secondary air pre-heater section (108) pre-heats secondary combustion air delivered via [24] by secondary combustion air blower (111) at between 1.15 bar and 1.22 bar (16.7 psia to 17.7 psia). The secondary combustion air exiting (108) via [61] is heated to between 149° C. and 204° C. (300° F. to 400° F.) and then reports to fluid bed combustor transport section (48).

Finally, completely cooled combustion products exiting primary air pre-heater section (107) and secondary air pre-heater section (108) via [112] enter a fabric filter bag-house (113) where residual fine ash is separated from combustion products. Ash [114] exits the system and particulate-free combustion products are discharged to atmosphere via [115] by combustor exhaust fan (116).

### Steam Calcination of Fine Limestone

CO₂ is liberated in a cylindrical, steam fluidized bubbling fluid bed calciner using inert hot media entering the calciner at a higher temperature than the calciner's bed operating temperature. The hot media releases its stored energy as the endothermic heat load required to calcine fine limestone to lime at the proper reaction conditions. Calciner fluidization steam enters at a controlled amount to insure that the gaseous CO₂-steam reaction atmosphere is continually maintained at a CO₂ partial pressure adequate to drive the calcination reaction. The CO₂-steam reaction atmosphere exiting the calciner, with the proper enthalpy requirement, is directed to a dryer/pre-heater to first dry and then preheat fine, wet limestone as provided by a quarry.

Gravity delivered to the fluid bed calciner feed injectors (53) is hot, stripped media [65] at a rate dependent on the calciner's and dryer/pre-heater's enthalpy requirement. The hot media is moved through the injectors by super-heated low pressure steam [87] delivered to the injector's hot media entry point at 204° C. (400° F.). The injector is preferably an “L” valve design, but may also be of the “J” type. Such valve designs are well known to those familiar with fluidized bed design techniques.

Pre-heated fine limestone is transported [91] by a pressurized CO₂/super-heated steam mixture to the calciner media injector, (53) at a point downstream of the steam/hot media mixing point. Blower (117) receives export quality CO₂ [118] from the CO₂ product area (outside of the invention's battery limits) and pressurizes it to ensure that the injection pressure into the cylindrical calciner bed is not less than 1.57 bar (22.7 psia). Superheated steam is injected into [91] via [90].

The resulting steam/hot media/dry fine limestone/CO₂ mixture is injected by calciner media injector (53) at a pressure not less than 1.57 bar (22.7 psia) into the base of cylindrical fluid bed calcination section (66) at a point directly above the calciner's circular gas distribution plate. The total number of injectors may vary from between four (4) and twenty-four (24) dependent on lime production capacity and calciner distribution plate cross-sectional area. The steam/CO₂ ratio in the injector internal path corresponds to a CO₂ partial pressure no greater than 90% of the CO₂ equilibrium partial pressure for the CaCO₃ calcination reaction to proceed at the injector's maximum internal pressure and minimum temperature.

Pre-heated fine limestone [91] may also be injected via a CO₂ and steam mixture directly into the calciner bed, thereby bypassing calciner media injector (53) should it be necessary to avoid excessive scaling in the injectors.

Calciner fluidization steam at 538° C. (1000° F.) is delivered [83] into the calciner fluidizing gas plenum (82). The steam pressure is not greater than 2.07 bar (30 psia) but at a pressure adequate to fluidize the bubbling media bed in fluid bed calcination section (66) at a fluidized bed height of no greater than 2.44 meters (8.0 feet). The steam amount entering calciner fluidizing gas plenum (82) will be controlled so as to ensure the CO₂ partial pressure in fluid bed calcination section (66) is no greater than 90% of the CO₂ equilibrium partial pressure in fluid bed calcination section (66)'s maximum fluidized bed pressure and minimum fluidized bed temperature when also considering steam/CO₂ mixtures contained in calciner input streams [91], [87] and [93]. Lastly, the total enthalpy, when considering temperature and mass amounts, contained in all gases exiting in stream [119] will be sufficient to satisfy the dryer/pre-heater's needs.

Fluid bed calcination section (66) is fluidized at the distributor plate top by steam at a velocity greater than the circulating media's incipient fluidization velocity but less than its maximum transport velocity of 6.1 mps (20 fps) and always greater than the smaller lime and fine limestone particles' transport velocity.

Fluid bed calcination section (66) expands in cylindrical cross-sectional area as CO₂ is liberated by the calcination reaction and stops expanding at calciner freeboard section (120) entry point. This increasing cross-sectional area ensures that the CO₂/steam gas mixture exits fluid bed calcination section (66) and enters calciner freeboard section (120) at a velocity greater than the media's incipient fluidization velocity but less than its minimum transport velocity but always greater than the smaller product lime particle's transport velocity. This ensures that elutriated lime product is transported into calciner freeboard section (120) and media is disengaged from the lime, falls back, and returns to fluid bed calcination section (66).

Cooled media exits the calciner through a gravity discharge overflow port located at the interface of fluid bed calcination section (66) and calciner freeboard section (120), i.e., the top surface of the calciner bubbling fluid bed. Media discharged from fluid bed calcination section (66) may contain some entrained lime. This lime, if returned to the combustor with the media will create an economic loss dependent on the fossil fuels' sulfur content and sorbent limestone cost. Therefore, the media/lime mix enters a “cone cap and slope” stripper (89) where the media/lime mix flows downward, by gravity, over a series of cone caps and slopes (see detail “A” on FIG. 4). Steam [88] at 2.07 bar (30 psia), or less, and pre-heated to 204° C. (400° F.) flows upward through the stripper, separating lime from the downward flowing media. Such stripper designs are well known to those familiar with refinery fluid catalytic cracking design techniques. The stripped lime and associated steam enter calciner freeboard section (120).

Cool, stripped media exits “cone cap and slope” stripper (89) via discharge stream [57], and is combined with make-up media [37] and recovered media [58] with all reporting to the media return valve (38). Valve (38) returns media to fluid bed combustor lower section (15) as previously explained. Valve (38) is preferably a “J” type valve but may also be an “L” type valve. Such valve designs are well known to those familiar with fluidized bed design techniques.

The number of strippers (89) and valves (38) will be not less than two (2) to ensure proper distribution of returned media into the fluid bed combustor lower section (15).

Lime particles elutriated into the calciner freeboard section (120) represent the total lime production rate. This lime, along with the exiting CO₂/steam gas mixture, exits calciner freeboard section (120) via stream [119] prior to entering hot cyclone (121).

The lime product particle temperature in both fluid bed calcination section (66) and calciner freeboard section (120) will be not less than 760° C. (1400° F.) and not greater than 854° C. (1570° F.) and typically between 816° C. (1500° F.) and 846° C. (1555° F.). Hot media entering fluid bed calcination section (66) via injectors (53) will be not less than 832° C. (1530° F.) and not greater than 927° C. (1700° F.). Cooled media entering media stripper (89) will typically be 28° C. (50° F.) higher than the exiting lime particle entering calciner freeboard section (120). This will ensure rapid heat transfer between the incoming hot media and the incoming pre-heated fine limestone.

The entire cylindrical calciner vessel represented by sections (82), (66), and (120) will surround combustor cylindrical, or rectangular, fluid bed combustor transport section (48). The combustor storage section (50) will share a common floor/roof with calciner freeboard section (120). In this manner the calciner and combustor are integrated into a compact, vertical design to minimize land area requirements. All interior surfaces of the calciner and combustor will be refractory lined for abrasion resistance and thermal insulation purposes. Such designs are well known to those familiar with fluidized bed design techniques.

### Fine Limestone Pre-heating and Drying

The hot CO₂, steam, and elutriated lime product mixture exiting calciner freeboard (120) via [119] is largely cleaned of lime in a hot cyclone (121). Separated larger particle lime, representing most of the lime production rate, exits cyclone (121) via [122] where it enters the first stage of the fluid bed cooler section, (123).

The hot CO₂/steam gas and very fine lime particle mixture exits cyclone (121) via [124]. This gas/solids mixture receives dried and partially pre-heated fine limestone [125] exiting the first cyclone stage (126) of the dryer/pre-heater section creating a denser gas/solids mixture, [127].

The gas/solids mixture stream [127] reports to the gas inlet of the second cyclone stage (128) of the dryer/pre-heater section. Within second stage cyclone (128), the dried and partially pre-heated fine limestone is further heated to between 200° C. (392° F.) and 380° C. (716° F.) but always less than 500° C. (932° F.). The final pre-heated limestone temperature will be a function of wet, fine limestone and calciner atmosphere properties. The separated, fully pre-heated fine limestone exits second stage cyclone (128) via stream [129] while exhaust gases exit second stage cyclone (128) via [130].

The separated pre-heated fine limestone exiting second stage cyclone (128) via stream [129] reports to the pre-heated limestone storage silo, (131).

The hot CO₂/steam gas and very fine lime and limestone particle mixture [130] exiting second stage cyclone (128) receives wet fine limestone [132] exiting the wet limestone storage silo (133) creating a denser gas/solids mixture, [134]. The wet fine limestone enters storage silo (133) via stream [135].

The gas/solids mixture stream [134] reports to the gas inlet of the first cyclone stage (126) of the dryer/pre-heater section. Within first stage cyclone (126), the wet, fine limestone (132) is dried and partially pre-heated. The final pre-heated limestone temperature will be a function of wet, fine limestone and calciner atmosphere properties. The separated dried and partially pre-heated fine limestone exits first cyclone stage (126) via stream [125] at typically above 88° C. (190° F.). Exhaust gases, at no greater than 204° C. (400° F.), exit first stage cyclone (126) via stream [136].

A very small portion of the CaO contained in the lime entering the dryer/pre-heater section hot gases via [124] is also re-hydrated and re-carbonated to Ca(OH)₂ and CaCO₃ due to the CO₂/water vapor mixture present in the dryer/pre-heater section. These re-hydrated and re-carbonated solids are mixed with dried fine limestone [91] reporting to calciner section (66) where it is re-calcined.

Gases [136] exiting first cyclone stage (126) of the dryer/pre-heater section containing the finest dried fine limestone particles, enter a fabric bag-house filter, or electrostatic precipitator (ESP), (137). The separated dried limestone particles exit (137) via a rotary valve and stream [138] and then report to the pre-heated limestone storage silo, (131).

The collected pre-heated limestone in silo (131) is discharged from its conical silo base through a multiplicity of discharge valves numbering no less than four (4) and no greater than twenty four (24) but always a number equivalent to the number of calciner hot media/fine limestone injectors, (53). Blower (117) receives CO₂ vapor [118] from the CO₂ product storage area (beyond this invention's battery limits) and boosts it to a pressure satisfactory to transport the pre-heated limestone that exits silo (131) to injectors (53) via (91) to ensure that the injector discharge pressure entering calciner section (66) is no less than 1.57 bar (22.7 psia).

Fine limestone-free gases exiting (137) are extracted by exhaust gas fan (139) that then deliver this CO₂/water vapor mixture [140] gas to a conventional direct contact water scrubber that largely separates the water vapor from all entering gases.

### Carbon Dioxide Recovery

The cleaned CO₂/water vapor mixture leaves the bag-house filter or ESP (137) via an exhaust fan (139) and reports to the direct contact water scrubber lower contact stage (141) via [140]. This direct contact water scrubber uses mill cooling tower water entering at approximately 38° C. (100° F.) and fresh mill water (143) at approx. 10° C. (50° F.) in its upper contact stage (144). This type design is well known to those familiar with the practice of purifying industrial gas streams.

The counter-current direct contact between cooling water and incoming hot gas further removes residual solid particles and condenses water vapor to concentrate CO₂ in the water scrubber's exhaust gas stream [145] to a saturation temperature of approximately 16° C. (60° F.). This low temperature, water-saturated CO₂ gas stream reports to a facility (beyond this invention's battery limits) designed to remove residual gaseous/solid impurities and create a useable liquid or gaseous CO₂ product. This technology is well known to those in the industrial gas industry.

Rejected scrubber water and small amounts of hydrated lime is collected in the direct contact scrubber sump at approximately 82° C. (180° F.) and reports [146] to a collection tank, (147). The vent gas [148] from (147) contains some CO₂ that is directed to the direct contact scrubber exhaust gas stream [145].

The collected hot water in tank (147) then flows to the mill's process hot water circuit via [149]. Sump drain [150] containing trace solids reports to the mill WWTP.

### Calcine Cooling

Hot lime [122] discharged from cyclone (121) report to a rectangular fluid bed cooler section (123) via a dip-leg seal. First fluid bed cooler section (123) is fluidized with steam [85] entering via first fluid bed cooler plenum section (84) at 2.07 bar (30 psia) and 538° C. (1100° F.) to ensure a proper seal between the cyclone dip-leg and ambient. Therefore, any gas drawn up into the negative pressure hot cyclone (121) does not to contaminate the CO₂ recovery loop with air.

The first fluid bed cooler section (123) is a “back-mix” fluidized bed design to ensure uniform mixing of fluidization steam and entering hot lime. The lime and steam mixture temperature in the first fluid bed cooler section (123) is no less than 600° C. (1112° F.) to ensure that no lime re-hydration occurs. The lime exits first fluid bed cooler section (123) by flowing over a full bed width divider wall and enters second fluid bed cooler section (105). Fluidization steam exits through the same divider wall opening, drawn by the negative draft created by cooler exhaust fan (151).

A portion of hot lime exits first fluid bed cooler section (123) via an overflow weir into a discharge port [152] at a controlled rate via a cone valve. The amount of lime entering [152] is between 0% and 20% of the total lime production rate. Lime in stream [152] is injected [93] into fluid bed calcination section (66) at a pressure no less than 1.57 bar (22.7 psia) by mill steam [92] at 2.07 bar (30 psia), and 204° C. (400° F.). Lime recycling ensures complete fine limestone calcination.

Lime entering the second fluid bed cooler section (105) is fluidized by ambient air [153] delivered by a blower (154) through second fluid bed cooler plenum section (155). The fluidized lime flows down the rectangular bed around immersed tube bundles within the fluidized bed. Flowing through this tube bundle, counter-flow to the solids flow, is pressurized mill boiler feed-water entering via [156]. Boiler feed-water, now heated to a higher temperature, exits via stream [104] and reports to the inlet of the steam drum (96). Excess heated boiler feed-water also exits via stream [157] and reports to the paper mill's boiler-house. Cooled lime exits second fluid bed cooler section (105) by flowing over a full bed width divider wall before entering third fluid bed cooler section (158).

Lime entering third fluid bed cooler section (158) is fluidized by ambient air delivered by a blower (154) through third fluid bed cooler section plenum (159). The fluidized lime flows along the rectangular fluid bed path around immersed tube bundles within the fluidized bed. Fresh mill water [160] flows through this tube bundle, counter-flow to the solids flow, boosted in pressure by a pump (161). Hot water exits via stream [162] and reports to the paper mill's process hot water circuit.

Instead of counter-flow pipe bundles, cross-flow plates or pipe bundles may also be utilized in fluid bed cooler sections (105) and (158), or another indirect heat transfer device known to those familiar with this type fluid bed cooler.

The water vapor/air mixture in the fluid bed cooler freeboard is withdrawn by an exhaust fan (151) via stream [163]. This exhaust stream reports to a fabric filter baghouse (164) and then exhausts to ambient via stream [165]. Collected fine particulate lime [166] reports with the bulk cooler lime flow [167] as stream [168] which reports to the PCC facility located adjacent to the paper mill.

The cooled lime, at approximately 93° C. to 121° C. (200° F. to 250° F.), exits the third fluid bed cooler section (158) via an overflow weir (169) with the rate controlled by a rotary valve which when combined with stream [167] becomes stream [168].

While the present invention has been exemplified by specific embodiments, it will be understood in view of the present disclosure that numerous variations upon the invention are now enabled to those skilled in the art. Accordingly, the invention is to be broadly construed and limited only by the scope the present disclosure.

1. A method for calcining fine particle limestone produced in a quarry and converting it to carbon dioxide and lime comprising:
(a) feeding fine particle limestone to a fluid bed calciner wherein the fluid bed calciner is thermally linked by moving media heat transfer (MMHT) to a circulating fluid bed combustor by a heat transfer media wherein said media moves between said calciner and said combustor wherein MMHT provides heat input for calcination;
(b) recycling the heat transfer media from said calciner to said combustor wherein said combustor receives one or more fuels selected from group consisting of waste water treatment (WWTP) sludge, biomass, and
(c) recovering carbon dioxide and lime product from the fluid bed calciner.

2. A method in accordance with claim 1, wherein steam is provided to the fluid bed calciner as fluidization and diluent gas.

3. A method in accordance with claim 1, wherein hot CO₂, steam, and lime product are produced from said calciner.

4. A method in accordance with claim 3, further comprising providing the hot CO₂, steam, and lime product to a separator to separate coarse lime and providing the hot CO₂/steam mixture and residual fine particle lime to a dryer/pre-heater.

5. A method in accordance with claim 1, further comprising before (a) providing wet fine particle limestone sufficiently near the fluid bed calciner and a dryer/pre-heater such that the dryer/pre-heater operate in counter/current gas/solids flow wherein exiting calciner gases substantially dry and pre-heat the wet fine particle limestone and the resulting dry limestone is fed to the calciner.

6. A method in accordance with claim 5, further comprising separating CO₂ in the exiting calciner gases from the steam by condensing the steam by contact with water in a cooling tower.

7. A method in accordance with claim 6, wherein hot process water created by steam condensation is returned to the manufacturing operation.

8. A method in accordance with claim 1, wherein the fluid calciner is a bubbling fluidized bed calciner wherein the fluidized bed comprises reheated media particles returning from the combustor.

9. A method in accordance with claim 1, further comprising providing a makeup media for said moving media to said circulating fluid bed combustor.

10. A method in accordance with claim 1, further comprising providing sorbent limestone to said circulating fluid bed combustor, to neutralize fuel derived SO₂.

11. A method in accordance with claim 1, further comprising providing a fossil fuel selected from a group consisting of coal, petroleum coke, waste coal and shredded tires to said combustor.

12. A method in accordance with claim 1, further comprising generating steam by heat exchange with hot combustion products.

13. A method in accordance with claim 1 further comprising preheating combustion air and calciner fluidizing steam by heat exchange with hot combustion products.

14. A method in accordance with claim 1 further comprising recovering heat from the lime.

15. A method in accordance with claim 1 further comprising injecting the dry limestone into the base of the fluidized media bed of the fluid bed calciner.

16. A system for calcining fine particle limestone and converting said limstone to carbon dioxide and lime comprising a bubbling fluid bed calciner, a circulating fluid bed combustor, an apparatus or system adapted to thermally link the bubbling fluid bed calciner and the circulating fluid bed combustor, and a dryer/pre-heater.
